(19) United States
(12) Patent Application Publication
(10) Pub. No.: US 2008/0310356 A1
(43) Pub. Date: Dec. 18, 2008

(54) System and Method for Large Packet Delivery During Semi-Persistently Allocated Session

(76) Inventors: Zhijun Cai, Euless, TX (US); James Earl Womack, Bedford, TX (US); Takashi Suzuki, Ichikawa (JP); Gordon Young, Shipston-on-Stour (GB); Wei Wu, Coppell, TX (US)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(21) Appl. No.: 11/969,082

(22) Filed: Jan. 3, 2008

Related U.S. Application Data
(60) Provisional application No. 60/944,376, filed on Jun. 15, 2007.

(51) Int. Cl. H04Q 7/20

(52) U.S. Cl. 370/329

(57) ABSTRACT

Systems and methods of delivering large IP packets during a semi-persistently allocated resource session. An additional resource allocation is dynamically made and signalled to a mobile device to indicate a resource to be used to deliver the large IP packet. The packet is then transmitted using the resource thus allocated.

### RELATED APPLICATION

This application claims the benefit of U.S. Provisional Application No. 60/944,376 filed Jun. 15, 2007.

### FIELD

The application relates to transmission of packets such as VoIP packet using semi-persistently allocated transmission resources.

### BACKGROUND

With semi-persistent scheduling, for downlink VoIP (voice over IP (Internet Protocol)) communications to a mobile device, a periodic DL (downlink) transmission resource is allocated during a talk-spurt on the downlink. The same resource is allocated each time. The allocation is turned on during each of the talk-spurts and off between talk-spurts. In this manner, explicit signalling to request an allocation, and to grant a particular VoIP allocation is not required. Semi-persistent scheduling for uplink VoIP communications from a mobile station is similar.

In addition to regular VoIP traffic, mobile devices also need the ability to send and transmit larger IP packets. Such larger IP packets are likely to be relatively infrequent compared to the frequency of regular VoIP transmissions. Such packets might include uncompressed IP packets, RTCP (Remote Transmit Power Control) packets, SIP/SDP (Session Initiation Protocol/Session Description Protocol) packets, etc. Such IP packets may be several hundreds of bytes in size and may have high priority. In addition, larger packets may be required to transmit RRC (Radio Resource Control) Signalling messages. Examples of this are handover related messages such as measurement reports. Some mobile devices will also need the ability to deliver a mixed service in which case services in addition to VoIP need to be provided to the mobile device, such as e-mail, web browsing etc.

### BRIEF DESCRIPTION OF THE DRAWINGS

Embodiments will now be described with reference to the attached drawings in which:

FIGS. 1 through 8 are flowcharts of methods of transmitting and receiving VoIP packets using semi-persistently allocated resources and sending and receiving additional packets;

FIG. 9 is a block diagram of a wireless system; and

FIG. 10 is a block diagram of a mobile device.

### DETAILED DESCRIPTION

According to one broad aspect, the application provides a method in a wireless network for transmitting to a mobile device, the method comprising: making a semi-persistent resource allocation for the mobile device for downlink transmission and signaling this to the mobile device; transmitting packets to the mobile device using the semi-persistent resource allocation; transmitting signaling to the mobile device that indicates an additional resource allocation; and transmitting an additional packet using the additional resource allocation.

According to another broad aspect, the application provides a method in a mobile device comprising: receiving a semi-persistent resource allocation for downlink packet transmission; receiving downlink packet transmissions on the semi-persistent resource; on an ongoing basis, monitoring downlink signaling for a grant of an additional resource allocation; and upon receipt of such a grant, the mobile device receiving an additional packet on the additional resource allocation.

According to another broad aspect, the application provides a method in a wireless network for receiving from a mobile device, the method comprising: making a semi-persistent resource allocation for the mobile device for uplink transmission and signaling this to the mobile device; receiving packets from the mobile device using the semi-persistent resource allocation; on an ongoing basis, monitoring for uplink signaling from the mobile device containing a request for an additional UL transmission resource allocation to transmit an additional UL packet; if a request is received, transmitting signaling to the mobile device that indicates an additional resource allocation; and receiving the uplink additional packet using the additional resource allocation.

According to another broad aspect, the application provides a method in a mobile device comprising: receiving a semi-persistent resource allocation for uplink packet transmission; transmitting packets on the semi-persistent resource allocation; when the mobile device has an additional packet to transmit, the mobile device transmitting a request for a grant of an additional resource allocation using uplink signaling; the mobile device monitoring downlink signaling for a grant of an additional uplink resource allocation; and upon receipt of such grant, the mobile device transmitting the additional packet on the additional resource allocation.

Another broad aspect provides a computer readable medium having computer readable instructions for controlling the execution of any of the methods summarized above, or detailed below.

Another broad aspect provides a a wireless network for providing wireless access to a mobile device, the wireless network comprising: a transmitter for transmitting to the mobile device; a semi-persistent scheduler for making a semi-persistent resource allocation for the mobile device for downlink transmission and signaling the semi-persistent resource allocation to the mobile device using the transmitter; a dynamic scheduler for making an additional resource allocation and signaling the additional resource allocation to the mobile device using the transmitter; and the transmitter being further configured to transmit packets to the mobile device using the semi-persistent resource allocation and to transmit the additional packet using the additional resource allocation.

Another broad aspect provides a mobile device comprising: a wireless access radio for receiving a semi-persistent resource allocation for downlink packet transmission, and for receiving downlink packet transmissions on a semi-persistent resource; a radio manager that, on an ongoing basis, monitors downlink signaling for a grant of an additional resource allocation; and the wireless access radio being further configured to receive an additional packet on the additional resource allocation upon receipt of such a grant.

Another broad aspect provides a wireless network for providing wireless access to a mobile device, the wireless network comprising: a transmitter for transmitting to the mobile device; a receiver for receiving from the mobile device, the receiver being configured to monitor for uplink signaling from the mobile device containing a request for an additional uplink transmission resource allocation to transmit an additional packet; a semi-persistent scheduler for making a semi-persistent resource allocation for the mobile device for uplink transmission and signaling the semi-persistent resource allocation to the mobile device using the transmitter; a dynamic scheduler for making an additional resource allocation for each request for an additional uplink transmission resource allocation received from the mobile device and signaling the additional resource allocation to the mobile device using the transmitter; and the receiver being further configured to receive packets from the mobile device using the semi-persistent resource allocation and to receive the additional packet using the additional resource allocation.

Another broad aspect provides a mobile device comprising: a wireless access radio for receiving a semi-persistent resource allocation for uplink packet transmission, and for transmitting uplink packet transmissions on the semi-persistent resource; a radio manager that generates a request for a grant of an additional uplink resource allocation and transmits this using the wireless access radio when the mobile device has an additional packet to transmit, and that monitors downlink signaling for a grant of an additional uplink resource allocation; and the wireless access radio being further configured to transmit an additional packet on the additional resource allocation upon receipt of such a grant.

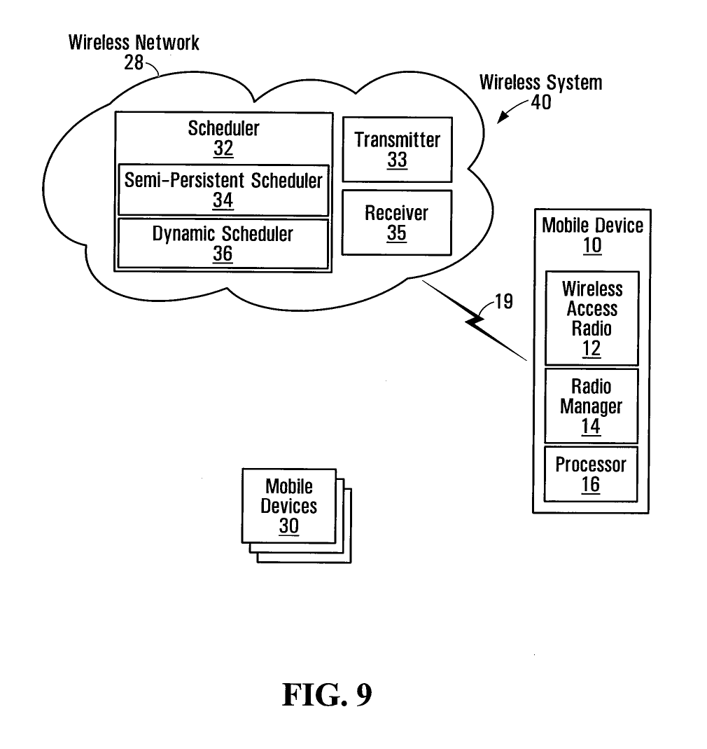

Referring now to FIG. 9, shown is a block diagram of an example wireless system 40. The wireless system 40 has a wireless network 28 and a mobile device 10. The wireless system also has other mobile devices 30.

The mobile device 10 has a wireless access radio 12, a processor 16 and a radio manager 14 that is responsible for controlling the wireless access radio 12. There may be additional components not shown. The wireless network 28 has a scheduler 32 that encompasses a semi-persistent scheduler 34 and a dynamic scheduler 36. The wireless network 28 has components such as base stations (not shown) for providing wireless access. These include a transmitter 33 and receiver 35. The scheduler 32 may reside in the base stations or elsewhere in the network 28. For example, in case of UTRAN Release 99, The RNC has a scheduler. In the examples that follow, it is assumed scheduler 32, transmitter 33 and receiver 35 are parts of a base station.

In the illustrated example, the scheduler 32 and radio manager 14 are implemented as software and executed on processors forming part of the network 28 and mobile device 10 respectively. However, more generally, these functions may be implemented as software, hardware, firmware, or any appropriate combination thereof.

Furthermore, it is to be understood that the wireless network would have any appropriate components suitable for a wireless network 28. Note that the wireless network may include wires that interconnect network components in addition to components for providing wireless communication with mobile devices. The components of the wireless network are implementation specific and may depend on the type of wireless network. There are many possibilities for the wireless network. The wireless network might for example be a UMTS network or an LTE network.

In operation, the mobile device 10 communicates with the wireless network 28 over a wireless connection 19 between the mobile device 10 and the wireless network 28. The communication with the wireless network 28 includes VoIP packet transmission and additional packet transmission. The semi-persistent scheduler 34 is responsible for making an initial resource allocation for a VoIP service to the mobile device 10. This includes an uplink allocation and a downlink semi-persistent resource allocation. The semi-persistent scheduler 34 is also responsible for keeping track of whether there is a talk-spurt in progress for the uplink and/or the downlink and for turning on and off the uplink and downlink allocation respectively. While de-allocated, the semi-persistently allocated resources can be made available for other purposes. Note that the form of the transmission resources that are being allocated is implementation specific. Particular examples of resources that might be used include OFDM resources and CDMA resources. The dynamic scheduler 36 is responsible for making resource allocations for additional packet transmissions that are not accommodated by the semi-persistent resource allocation. Specific methods are described below. Such allocations can be performed for the uplink and/or the downlink. The additional packets may be related to and/or form part of the VoIP service, or be unrelated the VoIP service.

In the mobile device, the radio manager 14 monitors downlink signalling to determine when an additional packet transmission has been scheduled on the uplink and/or downlink. In addition, the radio manager 14 generates signalling to request capacity to transmit such an additional packet on the uplink. Specific methods are described below.

### Dynamic Scheduling for the Downlink

### FIRST EXAMPLE

### Dynamic Scheduling for the Downlink with Layer 1 Control Channel

In a first example, the network makes the dynamic resource allocations independently from the semi-persistent scheduling and signals this using a layer 1 control channel. In this case, a resource grant is delivered to the mobile device by a layer 1 control channel. The mobile device monitors the control channel to look for grants. Upon receipt of such a grant, the mobile device then receives content on the downlink transmission resource allocated by the grant. For this approach, the mobile device may need to monitor the Layer 1 control channel continuously as it does not know when the control channel will be used to transmit a grant. In a particular example of a layer 1 control channel, every 1 ms, a signal is broadcast by a base station for reception by all mobile devices being serviced by the particular base station. Each signal can contain a dynamic resource allocation. There will be a dynamic resource allocation for each mobile device that is being allocated an additional packet. For a given one of the control channel signals, if there are no additional resource allocations to signal, the signal will not include any allocations.

The structure of the control channel is implementation specific. A specific example of a control channel that can be used for this purpose is that defined in the Long Term Evolution (LTE) the Physical Downlink Control Channel (PDCCH) as defined in TS36.211 hereby incorporated by reference in its entirety. PDCCH), The control signal will be transmitted in the first L OFDM symbols in the first slot of a subframe (L<=3). Each subframe is 1 ms, and each subframe is composed of 2 slots. The PDCCH always use QPSK modulation scheme. In another example, in HSDPA (high speed downlink packet access) the scheduling indication can be sent on HS-SCCH (High Speed Shared Control Channel) channel. HS-SCCH and PDCCH provide similar functions.

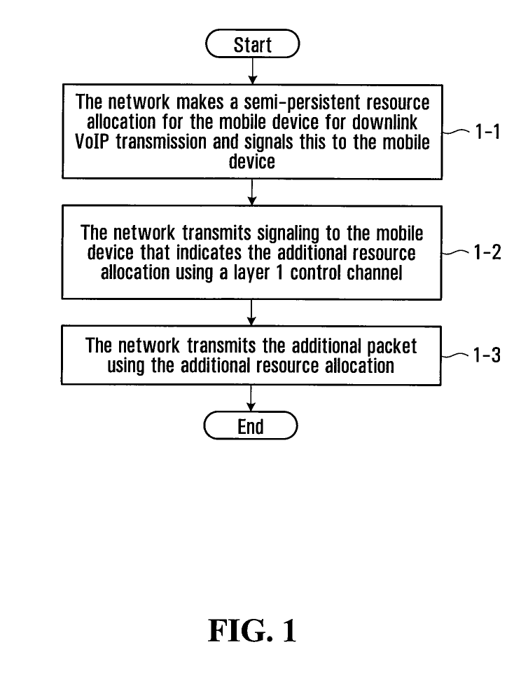

Referring to FIG. 1, shown is a flowchart of such a method from the perspective of a network providing service to a single mobile device. More generally, the network will perform such steps for each mobile device that is being provided service. At step 1-1, the network makes a semi-persistent resource allocation for downlink VoIP transmission and signals the semi-persistent resource allocation to the mobile device. This is done each time a new VoIP session starts and may be re-configured during the call. For the duration of a VoIP session, the network also transmits to the mobile device using the semi-persistent resource for periods that a DL talk burst is in progress. At step 1-2, the network transmits signaling to the mobile device that indicates an additional resource allocation to transmit an additional packet. This is sent using a layer 1 control channel. At step 1-3 the network transmits the additional packet using the additional resource allocation. Steps 1-2, 1-3 are performed for each additional packet that requires transmission.

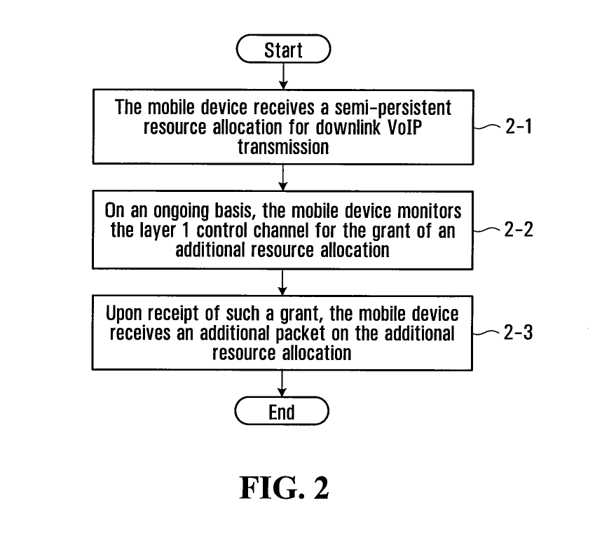

Referring to FIG. 2, shown is a flowchart of such a method from the perspective of a single mobile device. At step 2-1, the mobile device receives a semi-persistent resource allocation for downlink VoIP transmission. For the duration of a VoIP session, the mobile device also receives downlink VoIP transmissions on the semi-persistent resource during periods that a DL talk burst is in progress. At step 2-2, on an ongoing basis, the mobile device monitors the layer 1 control channel for the grant of an additional resource allocation. At step 2-3, upon receipt of such a grant, the mobile device receives an additional packet on the additional resource allocation. Step 2-3 is performed for each additional packet.

### SECOND EXAMPLE

### Dynamic Scheduling for the Downlink with MAC Layer Signaling

In a second example, the semi-persistent resource allocation and use is the same as for the first example. In addition, the network makes the dynamic resource allocations and signals this using MAC layer signaling. In a specific example, a downlink grant can be transmitted via MAC layer signaling that is encapsulated into the MAC header of a VoIP PDU. In this manner, the mobile device may not need to monitor the layer 1 control channel continuously. This is only for the initial transmission. If the mobile device sends back a NACK, the mobile device starts to monitor the layer 1 control channel for retransmission grants. For example, an optional field in the downlink VoIP MAC PDU header could contain the resource grant information. After the UE receives the VoIP PDU, it can obtain this optional header, and then the UE can start to receive the packets transmitted over the additionally granted resource.

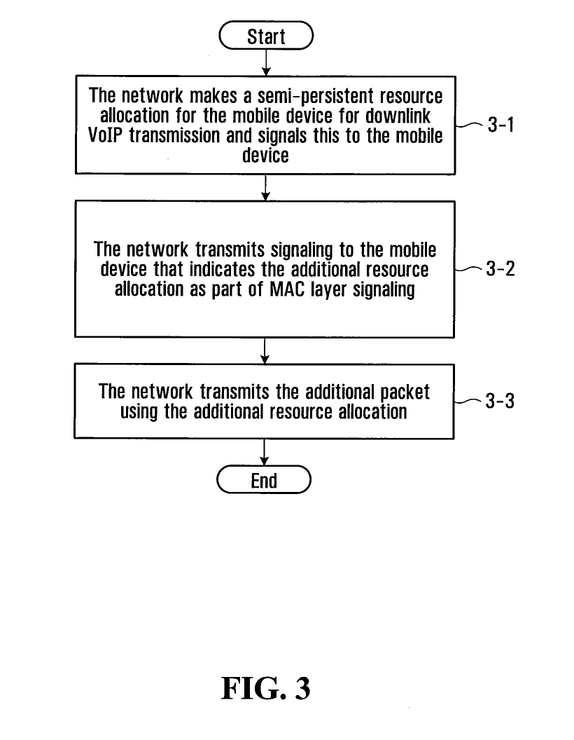

Referring to FIG. 3, shown is a flowchart of such a method from the perspective of a network providing service to a single mobile device. More generally, the network will perform such steps for each mobile device that is being provided service. At step 3-1, the network makes a semi-persistent resource allocation for the mobile device for downlink VoIP transmission and signals this to the mobile device. This might be done each time a new VoIP session starts. For the duration of a VoIP session, the network also transmits to the mobile device using the semi-persistent resource for periods that a DL talk burst is in progress. At step 3-2, the network transmits signaling to the mobile device that indicates an additional resource allocation to transmit an additional packet. This is sent as part of MAC layer signaling, for example included as part of the header of the next VoIP packet transmission to the particular mobile device. At step 3-3 the network transmits the additional packet using the additional resource allocation. Steps 3-2, 3-3 are performed for each additional packet that requires transmission.

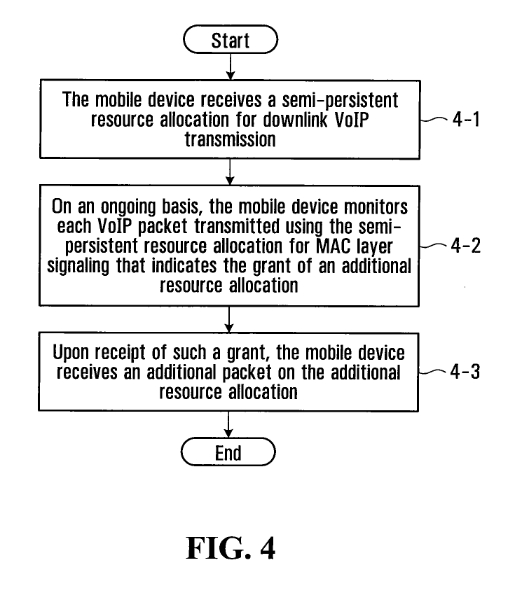

Referring to FIG. 4, shown is a flowchart of such a method from the perspective of a single mobile device. At step 4-1, the mobile device receives a semi-persistent resource allocation for downlink VoIP transmission. For the duration of a VoIP session, the mobile device also receives downlink VoIP transmissions on the semi-persistent resource during periods that a DL talk burst is in progress. At step 4-2, on an ongoing basis, the mobile device monitors each VoIP packet transmitted using the semi-persistent resource allocation for MAC layer signaling that indicates the grant of an additional resource allocation. More generally, the mobile device monitors MAC layer signaling. At step 4-3, upon receipt of such a grant, the mobile device receives an additional packet on the additional resource allocation. Step 4-3 is performed for each additional packet.

### Dynamic Scheduling for the Uplink

### FIRST EXAMPLE

### Dynamic Scheduling for the Uplink using RACH Procedure

In a first example, dynamic scheduling for the uplink is achieved using a contention based access channel. A specific example if such a contention-based access channel is the RACH (random access channel) channel defined in TS 36.211 hereby incorporated by reference in its entirety. In order to deliver an IP packet (other than UL semi-persistent scheduled packets), the mobile device can explicitly request an additional resource from the network using the contention-based access channel. After that, the mobile device monitors the downlink layer 1 control channel for an UL grant. Once allocated, the mobile device will start the uplink transmission using the resource signaled in the grant.

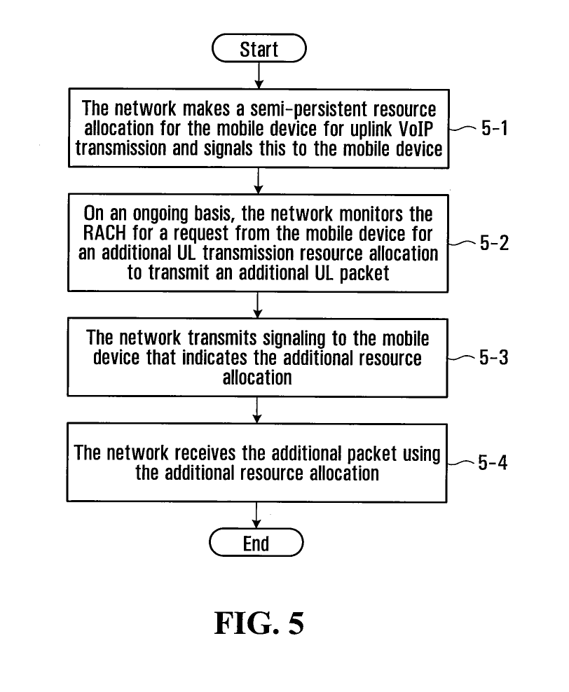

Referring to FIG. 5, shown is a flowchart of such a method from the perspective of a network providing service to a particular mobile device. At step 5-1, the network makes a semi-persistent resource allocation for the mobile device for uplink VoIP transmission and signals this to the mobile device. For the duration of a VoIP session, the network also receives from the mobile device using the semi-persistent resource for periods that a UL talk burst is in progress. At step 5-2, on an ongoing basis, the network monitors the RACH for a request from the mobile device for an additional UL transmission resource allocation to transmit an additional UL packet. More generally, the network monitors a contention-based access channel. At step 5-3, the network transmits signaling to the mobile device that indicates an additional resource allocation to transmit the additional packet. This is sent using any appropriate downlink signaling capacity. Specific examples include a downlink layer 1 control channel or MAC layer signaling as described previously for downlink allocations. At step 5-4 the network receives the additional packet using the additional resource allocation. Steps 5-2, 5-3, 5-4 are performed for each additional packet that requires transmission.

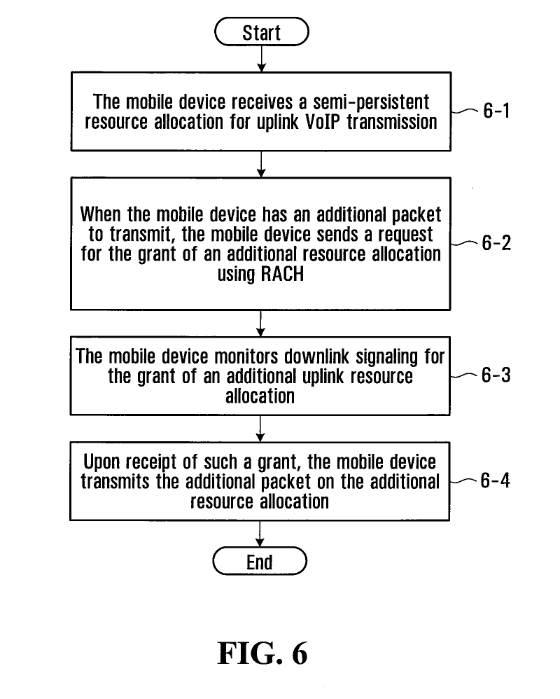

Referring to FIG. 6, shown is a flowchart of such a method from the perspective of a single mobile device. At step 6-1, the mobile device receives a semi-persistent resource allocation for uplink VoIP transmission. For the duration of a VoIP session, the mobile device also transmits uplink VoIP transmissions on the semi-persistent resource during periods that a UL talk burst is in progress. At step 6-2, when the mobile device has an additional packet to transmit, the mobile device sends a request for the grant of an additional resource allocation using RACH. More generally, the mobile device sends the request using a contention-based access channel. Given that this is a contention based channel, it is possible that several attempts may be necessary. At step 6-3, the mobile device monitors downlink signalling for the grant of an additional uplink resource allocation. This is received using any appropriate downlink signaling capacity. Specific examples include a downlink layer 1 control channel or MAC layer signaling as described previously for downlink allocations. At step 6-4, upon receipt of such a grant, the mobile device transmits the additional packet on the additional resource allocation. Steps 6-2, 6-3 and 6-4 are performed for each additional packet.

### SECOND EXAMPLE

### Dynamic Scheduling for the Uplink using MAC Signaling

In a second example, the mobile device uses UL MAC signaling to deliver the request for an additional resource. For example, in some embodiments an optional MAC header field in the UL VoIP PDU is used to deliver the “more resource required” message, and possibly to also indicate an amount of resource required. This avoids the need for the RACH procedure described in the first example. After that, the mobile device monitors the downlink layer 1 control channel for an UL grant. Once allocated, the mobile device will start the uplink transmission using the resource signaled in the grant.

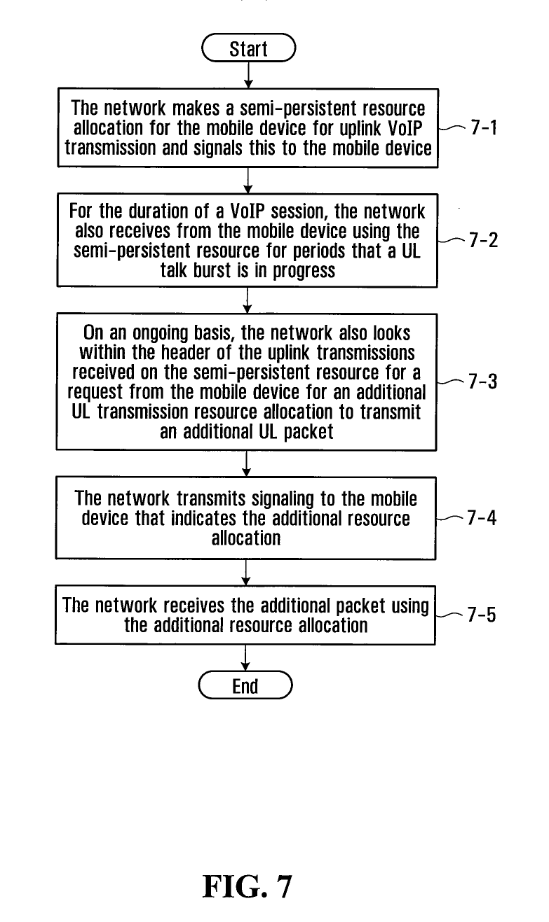

Referring to FIG. 7, shown is a flowchart of such a method from the perspective of a network providing service to a particular mobile device. At step 7-1, the network makes a semi-persistent resource allocation for the mobile device for uplink VoIP transmission and signals this to the mobile device. At step 7-2, for the duration of a VoIP session, the network also receives from the mobile device using the semi-persistent resource for periods that a UL talk burst is in progress. At step 7-3, on an ongoing basis, the network also looks within the header of the uplink transmissions received on the semi-persistent resource for a request from the mobile device for an additional UL transmission resource allocation to transmit an additional UL packet. At step 7-4, the network transmits signaling to the mobile device that indicates an additional resource allocation for the mobile device to transmit the additional packet. This is sent using any appropriate downlink signaling capacity. This may involve using a layer 1 control channel or MAC layer signaling as described previously for downlink allocation. At step 7-5 the network receives the additional packet using the additional resource allocation. Steps 7-3, 7-4, and 7-5 are performed for each additional packet that requires transmission.

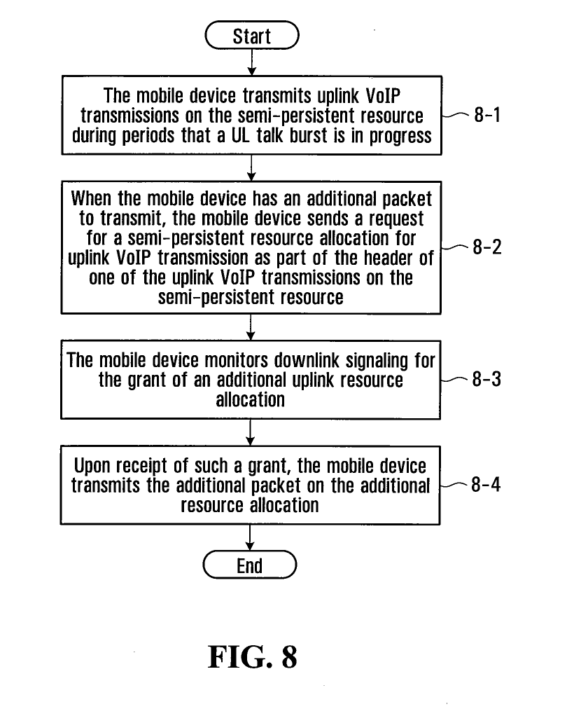

Referring to FIG. 8, shown is a flowchart of such a method from the perspective of a single mobile device. In step 8-1, for the duration of a VoIP session, the mobile device transmits uplink VoIP transmissions on the semi-persistent resource during periods that a UL talk burst is in progress. At step 8-2, when the mobile device has an additional packet to transmit, the mobile device sends a request for a semi-persistent resource allocation for uplink VoIP transmission as part of the header of one of the uplink VoIP transmission on the semi-persistent resource. At step 8-3, the mobile device monitors downlink signaling for the grant of an additional uplink resource allocation. At step 8-4, upon receipt of such a grant, the mobile device transmits the additional packet on the additional resource allocation. Steps 8-2, 8-3 and 8-4 are performed for each additional packet.

The above description has focused on applications where the traffic that is sent using the semi-persistent resource allocation is VoIP traffic. More generally, the same methods and systems can be applied to combine the transmission and scheduling of traffic of any type on a semi-persistently allocated resource with the transmission and scheduling of traffic that uses dynamic resource allocations.

In the above examples, Control Channel Elements, CCEs spaced by 1 ms are used for the downlink control channel. More generally, the downlink control channel can take any form. The only limitation is that dynamic allocations for a given mobile device take place during awake periods for the mobile device. Similarly, at least in the figures, the uplink control channel has been depicted as a contention based access channel being available at intervals spaced by 1 ms. More generally, an uplink control channel for requesting additional resource allocations can come in any form. The only limitation is that requests for dynamic allocations for uplink transmission from a given mobile device will need to be transmitted during awake periods for the mobile device.

### Another Mobile Device

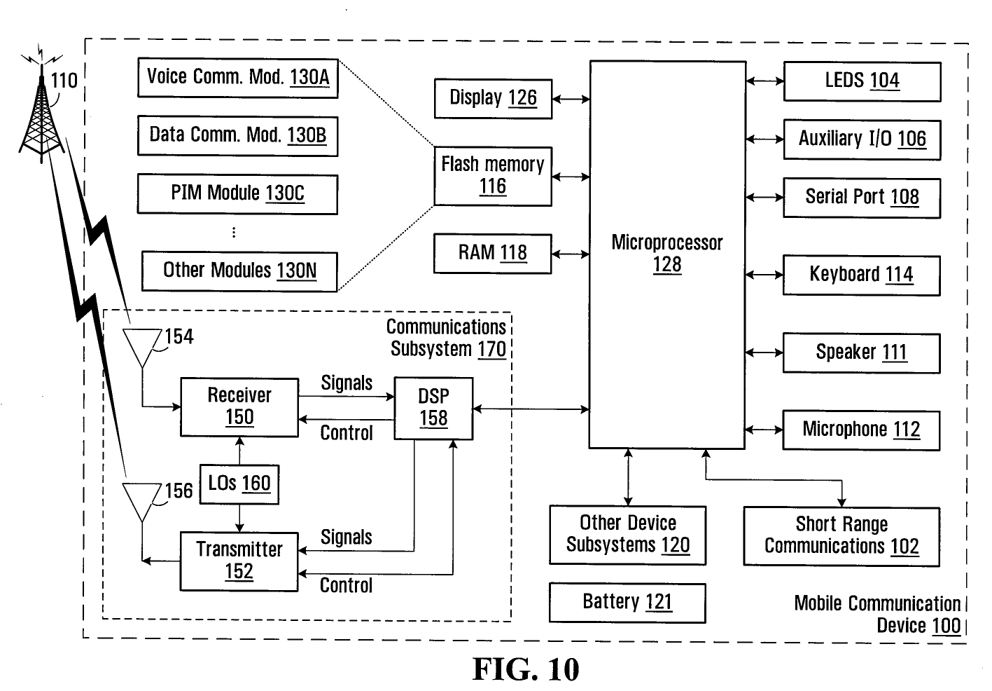

Referring now to FIG. 10, shown is a block diagram of another mobile device that may implement any of the mobile device methods described herein. The mobile device 100 is shown with specific components for implementing features similar to those of the mobile device 10 of FIG. 9. It is to be understood that the mobile device 100 is shown with very specific details for example purposes only.

A processing device (a microprocessor 128) is shown schematically as coupled between a keyboard 114 and a display 126. The microprocessor 128 may be a specific example of the processor with features similar to those of the processor 16 of the mobile device 10 shown in FIG. 9. The microprocessor 128 controls operation of the display 126, as well as overall operation of the mobile device 100, in response to actuation of keys on the keyboard 114 by a user.

The mobile device 100 has a housing that may be elongated vertically, or may take on other sizes and shapes (including clamshell housing structures). The keyboard 114 may include a mode selection key, or other hardware or software for switching between text entry and telephony entry.

In addition to the microprocessor 128, other parts of the mobile device 100 are shown schematically. These include: a communications subsystem 170; a short-range communications subsystem 102; the keyboard 114 and the display 126, along with other input/output devices including a set of LEDS 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some embodiments a two-way radio frequency (RF) communication device having voice and data communication capabilities. In addition, the mobile device 100 in some embodiments has the capability to communicate with other computer systems via the Internet.

Operating system software executed by the microprocessor 128 is in some embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some embodiments capable of organizing and managing data items, such as e-mail, calendar events, voice mails, appointments, and task items. The PIM application is also in some embodiments capable of transmitting and receiving data items via a wireless network 110. In some embodiments, the data items managed by the PIM application are seamlessly integrated, synchronized and updated via the wireless network 110 with the device user's corresponding data items stored or associated with a host computer system. As well, additional software modules, illustrated as another software module 130N, may be installed during manufacture. One or more of the modules 130A,130B,130C,130N of the flash memory 116 can be configured for implementing features similar to those of the radio manager 14 of the mobile device 10 shown in FIG. 9.

Communication functions, including data and voice communications, are performed through the communication subsystem 170, and possibly through the short-range communications subsystem 102. The communication subsystem 170 includes a receiver 150, a transmitter 152 and one or more antennas, illustrated as a receive antenna 154 and a transmit antenna 156. In addition, the communication subsystem 170 also includes a processing module, such as a digital signal processor (DSP) 158, and local oscillators (LOs) 160. The communication subsystem 170 having the transmitter 152 and the receiver 150 is an implementation of a specific example of the wireless access radio 12 of the mobile device 10 shown in FIG. 9. The specific design and implementation of the communication subsystem 170 is dependent upon the communication network in which the mobile device 100 is intended to operate. For example, the communication subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. The communication subsystem 170 may also be designed to operate with an 802.11 Wi-Fi network, and/or an 802.16 WiMAX network. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150 and the transmitter 152. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using the keyboard 114 and/or some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

The short-range communications subsystem 102 enables communication between the mobile device 100 and other proximate systems or devices, which need not necessarily be similar devices. For example, the short-range communications subsystem may include an infrared device and associated circuits and components, or a Bluetooth™ communication module to provide for communication with similarly-enabled systems and devices.

Numerous modifications and variations of the present invention are possible in light of the above teachings. It is therefore to be understood that within the scope of the appended claims, the invention may be practiced otherwise than as specifically described herein.

We claim:

1. A method in a wireless network for transmitting to a mobile device, the method comprising:
making a semi-persistent resource allocation for the mobile device for downlink transmission and signaling this to the mobile device;
transmitting packets to the mobile device using the semi-persistent resource allocation;
transmitting signaling to the mobile device that indicates an additional resource allocation; and
transmitting an additional packet using the additional resource allocation.

2. The method of claim 1 wherein:
transmitting signaling to the mobile device that indicates the additional resource allocation comprises using a layer 1 control channel.

3. The method of claim 1 wherein:
transmitting signaling to the mobile device that indicates the additional resource allocation comprises using a MAC layer signaling.

4. The method of claim 3 wherein using a MAC layer signaling comprises transmitting an optional field in one of the packets transmitted using the semi-persistent resource allocation.

5. A method in a mobile device comprising:
receiving a semi-persistent resource allocation for downlink packet transmission;
receiving downlink packet transmissions on the semi-persistent resource;
on an ongoing basis, monitoring downlink signaling for a grant of an additional resource allocation; and
upon receipt of such a grant, the mobile device receiving an additional packet on the additional resource allocation.

6. The method of claim 5 wherein on an ongoing basis, monitoring downlink signaling for a grant of an additional resource allocation comprises monitoring a layer 1 control channel.

7. The method of claim 5 wherein on an ongoing basis, monitoring downlink signaling for a grant of an additional resource allocation comprises monitoring MAC layer signaling.

8. The method of claim 7 wherein monitoring MAC layer signaling comprises processing a header of each downlink packet transmitted on the semi-persistent resource to look for the grant.

9. A method in a wireless network for receiving from a mobile device, the method comprising:
making a semi-persistent resource allocation for the mobile device for uplink transmission and signaling this to the mobile device;
receiving packets from the mobile device using the semi-persistent resource allocation;
on an ongoing basis, monitoring for uplink signaling from the mobile device containing a request for an additional UL transmission resource allocation to transmit an additional UL packet;
if a request is received, transmitting signaling to the mobile device that indicates an additional resource allocation; and
receiving the uplink additional packet using the additional resource allocation.

10. The method of claim 9 wherein on an ongoing basis, the network monitors for uplink signaling from the mobile device containing a request for an additional UL transmission resource allocation to transmit an additional UL packet comprises monitoring a contention-based access channel.

11. The method of claim 10 wherein monitoring a contention-based access channel comprises monitoring a random access channel.

12. The method of claim 9 wherein on an ongoing basis, the network monitors for uplink signaling from the mobile device containing a request for an additional UL transmission resource allocation to transmit an additional UL packet comprises monitoring MAC layer signaling.

13. The method of claim 12 wherein monitoring MAC layer signaling comprises looking at a header of each packet transmitted using the semi-persistent uplink allocation.

14. A method in a mobile device comprising:
receiving a semi-persistent resource allocation for uplink packet transmission;
transmitting packets on the semi-persistent resource allocation;
when the mobile device has an additional packet to transmit, the mobile device transmitting a request for a grant of an additional resource allocation using uplink signaling;
the mobile device monitoring downlink signaling for a grant of an additional uplink resource allocation; and
upon receipt of such grant, the mobile device transmitting the additional packet on the additional resource allocation.

15. The method of claim 14 wherein the mobile device transmitting a request for the grant of an additional resource allocation using uplink signaling comprises transmitting the request using a contention-based access channel.

16. The method of claim 15 wherein transmitting the request using a contention-based access channel comprises transmitting using a random access channel.

17. The method of claim 14 wherein the mobile device transmitting a request for the grant of an additional resource allocation using uplink signaling comprises transmitting the request using MAC layer signaling.

18. The method of claim 17 wherein transmitting the request using MAC layer signaling comprises transmitting the request as part of a header of one of the packets transmitted using the semi-persistent resource allocation.

19. The method of claim 1 wherein packets transmitted on the semi-persistent resource comprise of VoIP packets.
